(19) United States
(12) Patent Application Publication
(10) Pub. No.: US 2005/0216519 A1
(43) Pub. Date: Sep. 29, 2005

(54) Access point that monitors guest usage

(76) Inventors: Glenna G. Mayo, San Jose, CA (US); Jeffrey D. Meyer, Sunnyvale, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/811,259

(22) Filed: Mar. 26, 2004

(51) Int. Cl. G06F 7/00

(52) U.S. Cl. 707/200

(57) ABSTRACT

An access point or on-ramp includes a web server interface that couples one or more guests to the Internet. A usage collector monitors the usage patterns of the guests, and web cache software selects web pages that may be of interest to the guests based on their usage patterns. Another embodiment includes a remote management server managing a plurality of access points. The remote management server also may be used to enhance the functionality of access points by providing enhanced recognition of usage patterns. Information may be downloaded from the remote management server to the access point once the server recognizes usage patterns.

### BACKGROUND

For many computer users, Internet access is a basic necessity. Many computer system users desire Internet access so they can retrieve information from websites, shop on-line, send and receive email, download software programs or patches, manage data and files, or perform any of the many other tasks or functions that are possible with Internet access. Until relatively recently, a user desiring Internet access was required to establish a cable connection from the user's computer to a telephone jack, DSL connection, or cable connection. Alternatively, a user could connect a computer to the Internet through a local area network (LAN) connection.

Wireless networks permit computers to access the Internet without requiring physical cables between the computer and a broadband or phone connection, or between the computer and LAN. Instead of physical cables, the computer connects to the broadband or phone connection via wireless transmissions, such as radio frequency (rf) waves. A wireless access point, which includes an antenna for transmitting and receiving wireless transmissions, links the computer to the broadband or phone connection.

Wireless access points are designed to permit multiple computers to conduct wireless transmissions simultaneously, so that a plurality of computer users may access the Internet through the same wireless access point. As a result, each computer in a wireless network is assigned a unique address that then is used to perform Internet communications through the access point.

Because wireless networks do not require cabling to connect a computer to the Internet, it has become increasingly popular for business establishments or hosts to provide wireless access points or “on-ramps” to enable customers and/or employees to access the Internet and email accounts. However, oftentimes the host may have limited knowledge regarding the operation and maintenance of computer systems. In addition, because the host may receive little or no compensation for use of the access point, it may not be economical for the host to invest in expensive software or hardware to intelligently manage the access point.

### BRIEF SUMMARY

An access point includes an interface that permits one or more guests to obtain Internet access. The access point includes monitoring logic that determines the usage of each guest. The guest usage is used to locally cache information that may be of interest to guests of the access point.

According to another embodiment, a method of providing guests with Internet service comprises detecting a request for Internet access from a guest and monitoring usage patterns of that guest. The method further includes predicting information that may be of interest to the guest based on the guest's usage patterns, and caching the information of interest in a local memory.

Yet another embodiment includes a system for remotely managing a plurality of Internet access points that are capable of collecting guest usage information. A remote management server couples to the access points via the Internet to receive guest usage information, from which the remote management server detects usage patterns and downloads information to the access point to enhance operation.

Another embodiment includes an Internet on-ramp that permits multiple guests to obtain Internet access. The on-ramp includes means for interfacing the access point with the guests and means for coupling the access point to the Internet. The on-ramp further includes monitoring means to collect information on a guest's usage, and a selecting means that selects content that may be of interest to the guest based on the guest's usage that is stored in a local storage means.

These and other embodiments of the invention will become apparent upon a review of the drawings and detailed description.

### BRIEF DESCRIPTION OF THE DRAWINGS

For a detailed description of the embodiments of the invention, reference will now be made to the accompanying drawings in which:

FIG. 1 shows an exemplary system block diagram of a remote management access point; and

FIG. 2 is a block diagram illustrating a remote management system managing a plurality of access points.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct electrical connection. Thus, if a first device couples to a second device, that connection may be through a direct electrical connection, or through an indirect electrical connection via other devices and connections. The term “access point”, as used herein, is intended to mean a device that operates as a bridge or hub to link one or more computer systems to a broadband or telephone connector from which Internet access may be obtained. An Internet cafe refers to a business establishment or other structured environment that includes infrastructure to enable customers, employees and/or students to obtain Internet access. Unless otherwise indicated, embodiments discussed herein should be construed as exemplary, and not intended to be limiting in scope.

### DETAILED DESCRIPTION

The following discussion is directed to various embodiments of the invention. One skilled in the art will appreciate that the following description has broad application, and the discussion of any embodiment is meant only to be exemplary and not intended to intimate or suggest that the scope of the disclosure and claims is limited to that embodiment, unless explicitly indicated.

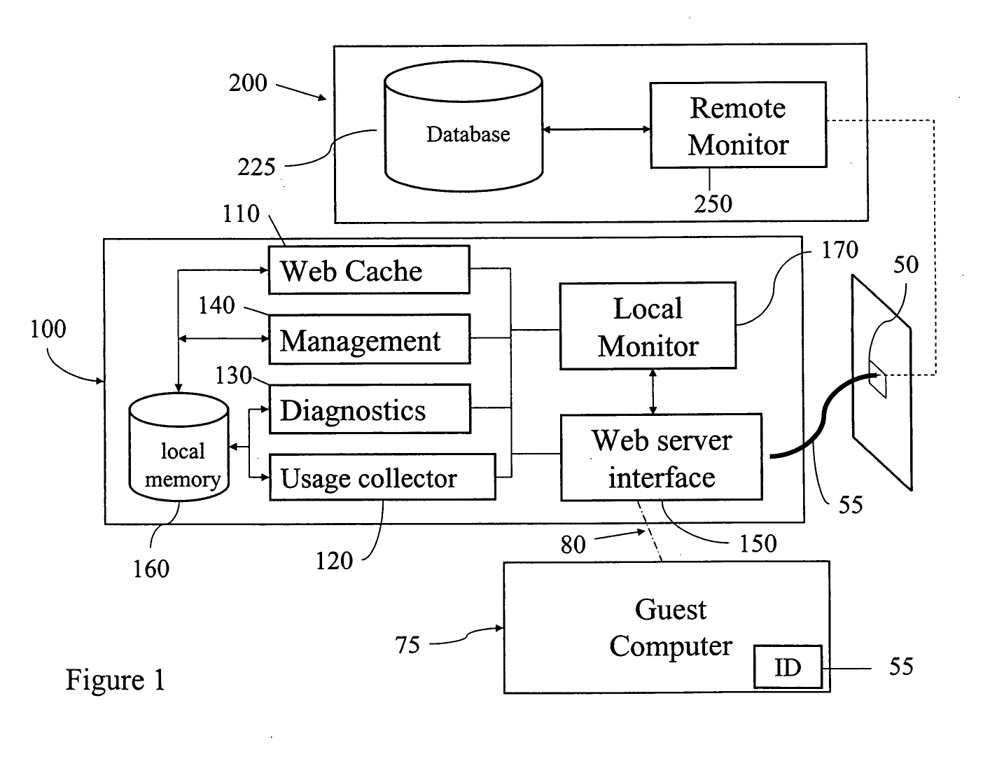

Referring now to FIG. 1, a wireless access point 100 constructed according to an exemplary embodiment couples to a jack 50 or other connector from which Internet service may be obtained. The jack 50 may comprise a conventional phone connection through which an Internet connection may be established, or may comprise a broadband Internet connection such as cable, DSL, satellite or fiber optic. As one skilled in the art will appreciate, the jack 50 couples via a suitable transmission medium to an Internet Service Provider (ISP) or directly to the LAN, to thereby provide Internet access to appropriate devices when coupled to jack 50.

The access point 100 may couple to jack 50 via an electrical or fiber optic cable 55. Alternatively, any other suitable communication medium, including wireless transmissions, may be used to couple the access point 100 to jack 50. The jack 50 may be located in a wall or floor of a room or patio, or any other convenient location permitting physical access via a communication medium. Thus, according to the exemplary embodiment of FIG. 1, access point 100 includes a connector (not shown) through which an Internet connection can be established. Although also not shown, the access point 100 may couple via a suitable cable to a local area network (LAN) connector. Thus, for example, access point 100 may include a connector that mates with an Ethernet cable to establish a connection with a LAN, once the cable is inserted in an Ethernet jack. As yet another alternative, the access point 100 may couple to the Internet via an Internet server on a LAN, in which case it may be unnecessary to couple the access point directly to an Internet connector, such as jack 50.

A business entity may supply the access point 100 to provide customers, employees and/or students (generically referred to herein as guests) Internet access. One such customer (Guest Computer 75) is depicted in FIG. 1 for purposes of illustration, with the understanding that multiple Guest devices might be supported. The owner or manager (referred to herein as the host) of the access point 100 may configure and control the access point via a host PC (not shown), which may couple to the access point via a LAN connection, or through a wireless communication link. Alternatively, the access point 100 may be configured and managed by a remote management system 200, as will be described in more detail below. According to the embodiment of FIG. 1, the Guest Computer 75 couples to access point 100 via a wireless transmission link 80, or by some other suitable form of communication. The wireless communication link between the access point and the Guest Computer in FIG. 1 may conform to protocols established by IEEE 802.11b or IEEE 802.11g, or any other suitable protocol that supports wireless transmissions, including for example, Bluetooth wireless technology.

The Guest Computer 75 may include any type of portable or desktop computing system. Thus, for example, a guest of a business establishment may use a computing system provided by the host, or may use the guest's own computing device. Such computing devices include laptop computers, personal device assistants, pocket PCs, and the like. According to the embodiments exemplified by FIG. 1, the Guest Computer 75 includes an identification mechanism 55, which functions to identify the owner/user of the Guest Computer 75. The identification mechanism may comprise any of a variety of mechanisms, including an ID chip in the Guest computer, a scanner or reader for reading a loyalty card (a card given to customers to track patronage), credit card, or other identification card, or other security type devices that are capable of identifying personal or physical attributes of a user. Alternatively, the access point may assist guests in configuring user names and passwords, through which a guest's identity may be determined.

According to the exemplary embodiments of FIG. 1, the access point 100 appears and operates in a manner similar to an appliance. Stated differently, the access point exhibits a small form-factor, and has relatively few inputs and outputs to simplify its use. Further, the access point 100 may be set up with little user support, other than connecting the access point to an Internet connector 50, and if desired, to a LAN connector, and then turning on (or powering-up) the unit.

Operationally, the access point is self-managing, with minimal intervention on the part of the host. The access point manages its operation and the content provided to guests based on usage patterns that are measured. These usage patterns include the content and web sites requested by the user, and system parameters relating to performance. By monitoring these usage patterns, the access point can be configured to operate in an intelligent, adaptive fashion. In addition, information regarding the usage patterns may be uploaded to a remote management server, where the patterns may be analyzed by artificial intelligence software that may be impractical to run locally in conjunction with the access point.

Referring still to FIG. 1, the access point 100 includes a variety of hardware and/or software components to provide enhanced functionality to guests. As shown in the exemplary embodiment of FIG. 1, the access point 100 includes a web server interface 150, a local monitor 170, and several web applications 110, 120, 130, 140. According to the embodiments exemplified by FIG. 1, these functional components are implemented in software executing locally on a microprocessor (not shown), with the understanding that any or all of these components may alternatively be configured in hardware or a combination of hardware and software. In addition to these software components, the access point 100 may include a local memory 160 that stores software applications until executed by the processor. The local memory 160 also stores data gathered and manipulated by the other functional components of the access point 100. The local memory 160 may take any conventional form, including any type of hard drive storage, random access memory, or read only memory, or a combination thereof. Other components typically included in an access point have been omitted for the sake of brevity.

The web server interface 150 couples to an Internet connector, such as jack 50, and also couples to one or more Guests 75. The web server interface 150 functions as an on-ramp to permit guests to access the Internet. As noted above, the web server 150 may connect via an electrical cable or other communication medium to a phone line or broadband connection, or may couple via an Ethernet cord or other communication medium to an Internet server resident on a local area network. As shown in the exemplary embodiment of FIG. 1, the Guest 75 couples to the web server interface 150 through a wireless transmission medium, although the use of another communication medium is acceptable. If desired, the communications between the Guest PC 75 and the web interface 150 may be encrypted after initial handshaking and authentication is completed. The wireless communications between the Guest and web interface may conform to existing standards such IEEE 802.11b, IEEE 802.11g, or Bluetooth, or other proprietary or industrial standards that have been or may be developed in the future.

The web server interface 150 executes an appropriate web server software application capable of presenting web pages and performing other tasks on the clients behalf, such as logging on or logging off, acquiring new services (and possibly collecting payment) as well as providing the host with a mechanism to control other services available via the access point. Clients use a web browser software application such as Internet Explorer® software sold by Microsoft Corp.@, although it should be understood that any generic browser may be used. During operation, the web server interface 150 executes the web server software application, which enables the access point 100 to locate and retrieve data maintained on the access point or from other Internet services. This data may be passed to other devices that couple to the access point 100, or may be used by other functional components which form a part of the access point 100 to configure, operate, and maintain the access point.

The web server interface 150 also may include logic to assign each Guest Computer 75 an Internet Protocol (IP) address to enable the access point to route requested web pages and email to the appropriate Guest. The IP address may be assigned by a dynamic host configuration protocol (DHCP) logic (not shown). In embodiments where a Guest Computer has an identification mechanism 55, the IP address may be associated with the Guest's ID.

The web server interface 150 may also include firewall protection and authentication software. The firewall protection portion of interface 150 prevents external attackers and viruses from obtaining access to the access point or to any computer coupled to the access point. Various commercial applications are available for implementing such firewall protection, and may be used in the exemplary embodiment of FIG. 1. The authentication software determines if a Guest 75 has been authenticated to access and use the access point 100. Based on the configuration of the access point, Guests may be required to have purchased products or services offered by the Host, or to have paid the Host for the right to use the access point. Further, the content available to Guests may vary depending on what they have purchased from the host, or what they have paid the Host. According to the exemplary embodiment of FIG. 1, the authentication software compares the Guest ID with a list of approved users of the access point, and if multiple access levels are available, determines the access level of that Guest ID.

Referring still to FIG. 1, the access point 100 may support a number of web applications, including a web cache 110, a usage collector 120, diagnostics 130, and a management application 140. These web applications operate generally under the supervision of the local monitor 170.

The local monitor 170 operates as a supervisor to insure the web applications 1 10, 120, 130, 140 are executing properly and coordinating together. Data from the applications may be collected by local monitor 160. The local monitor 160 further analyzes the collected data and transfers the analyzed data to the Remote Management server 200 for additional analysis. This analysis by the local monitor may comprise filtering, sampling, or summarizing the collected data. Thus, for example, the local monitor 170 may quantify the number of times a particular web site has been requested on a cumulative level by multiple guests.

The local monitor also may be used to dynamically generate a page that can be viewed by Guest 75 or by a Remote Management server 200 that includes information of interest based on data and analysis generated by the other applications. Thus, for example, when accessed by the Remote Management server 200, the local monitor 160 may provide a summary page of system status information, and highlight any errors or problems detected since the last Remote server access. The local monitor 170 also may be useful in gathering statistical information regarding usage patterns of Guests, including the number or percent of unauthorized users, the number of times each web site was visited by a guest, a list of favorite web sites, and many, many other types of information, which may be displayed to all Guests, or relayed to the Remote Management server 200.

The usage collector 120 collects a variety of different user information, including the number of packets transferred across the web server interface 150, the applications that a user is selecting, the kind of content a guest is accessing, and the like. In particular, the usage collector 120 may determine which web destinations are being accessed by a guest, or may identify what host provided services are being used. Similarly, the usage collector 120 may monitor system information, such as data storage patterns, bandwidth or throughput characteristics, network patterns, and the like.

The information collected may be coordinated with a particular user based on the Guest ID, or alternatively, the IP address of the guest. The correlation between the Guest IP address and the Guest ID may be subject to security to insure that other users or even the host cannot specifically identify a particular guest to insure an adequate level of privacy. Alternatively, a usage ID may be established for each Guest for purposes of collecting usage information. In instances where privacy is a concern, the Guest ID may be discarded once the Guest ID is correlated with a usage ID or an IP address.

Information gathered by the usage collector 120 may be used by the other web applications (the web cache 110, diagnostics 130, and management 140) to provide enhanced functionality to the access point 100. Thus, for example, if the bandwidth between the web server interface 150 and the Guest Computer 75 starts to drop, or the access time to retrieve a web site increases to an unacceptable level, that information may be used to flag to indicate that diagnostics need to be run to determine the reason for the drop in bandwidth or performance. The diagnostics application 130 then may be executed to determine what the cause was for the drop in performance. The identification of this problem then may trigger the management application 140 to seek a download or patch to correct the problem, or provide a message to the Remote Management server 200 indicating the problem that has been experienced at the local access point 100.

The web cache 110 operates in conjunction with the access point local memory 160 to store or cache web pages determined by the web cache application to be of special interest. This caching of special web pages minimizes the time to access these web pages in the event a subsequent guests requests these same web pages. Web pages may be deemed of special interest if multiple guests have accessed the same web page. Thus, if a particular web site is visited repeatedly, then that web site may be cached locally in the local memory 160 by the web cache application 1 10. The web cache application 110 may also proactively cache web sites or other items that the web cache predicts a guest (or guests) may want, based on usage patterns that the web cache 100 has obtained from usage collector 120 regarding a particular guest or guests. As an example, if a Guest is selecting web sites relating to auto repair topics, the web cache application may proactively cache (on local memory 160) certain web sites relating to auto repair that are commonly visited by users seeking auto repair information. Once those non-requested web sites have been cached, then the web server interface 75 may indicate to the Guest that additional web sites of interest are available for viewing.

Software to support these predictive capabilities of the web cache application 110 may reside locally in the access point, or may reside in the Remote Management server. Because such predictive software oftentimes is expensive and computationally intensive, in many instances that sort of predictive or artificial intelligence software may reside at the Remote Management server 200. In that event, the web cache application 110, usage collector 120, and local monitor 170 may provide summaries of usage patterns to the remote monitor, which submits the usage pattern to an artificial intelligence engine in an attempt to identify patterns or predict future guest activity.

The web cache application 110 operates dynamically, based on information obtained by the data collector 120. Thus, as usage changes, or as further insight is gathered into usage patterns (either locally or remotely), the web cache application 110 will attempt to predict guest usage, and also will cache websites and other information that is repeatedly accessed by a user or users or which is likely to be of interest to a guest or guests based on usage patterns. In addition, the web site application may be modified or replaced by the Remote Management server 200 based on information gathered by the usage collector 200. Thus, if a particular pattern of usage is detected, and the remote monitor 250 determines that particular software is very good at predicting results based on that pattern of usage, the remote monitor 250 may cause that predictive software to be downloaded to the access point as part of the web cache software 110.

The diagnostics application 130 reflects the concept that portions of diagnostics software may be cached locally in the access point 100 to permit the execution of diagnostic software on the local processor. The diagnostic application 130 may cause tasks to be scheduled periodically to check system performance, or may be called in the event that a malfunction is detected based on the data obtained by the usage collector 120. The diagnostic application(s) 130 maintained in the access point may change on a dynamic basis, based on usage conditions detected by the usage collector application 120. Thus, if a particular condition is detected, the Remote Management server 200 may cause diagnostic software pertinent to that condition to be downloaded to the access point 100. As conditions change, this diagnostic software may be replaced by other diagnostic software that is more pertinent to analyzing the newly detected condition. The selection of the appropriate diagnostic software may be done by the Remote Management server 200 based on the data obtained from the local usage collector 120, using a meta-tag index to associate particular programs stored remotely at the server 200 with various diagnostic issues. In addition, the diagnostic application 140 may itself request further downloads to address specific analytical issues within its domain.

The management application 140 includes the ability to configure the local monitor 170 to enable the local monitor to supply summary information regarding the access point to the remote management server 200. Information may include identifying the address of the access point, the bandwidth of the Internet connection, the bandwidth of the wireless connections to all guests, any unresolved error messages, a summary of web sites requested by recent guests, average web page access times, average download speeds, a summary of recent diagnostic or maintenance analysis, average memory access times, the number and identity of currently-cached web pages, and a variety of other information deemed useful by the remote management server. The management application 140 also may provide periodic back-up of data and files stored in local storage 160. The management application 140 also determines how long usage information is maintained, which programs are replaced as new programs are downloaded, and similar housekeeping matters.

The management application operates in conjunction with the diagnostic application 130 and usage collector 120 to optimize the applications cached in local memory 160. The content in the management application 140 changes dynamically based on information gathered by the usage collector 120 and the diagnostic application. Thus, as the diagnostic application 130 identifies a particular error or sub-optimal condition, the management application 140 functions to retrieve an appropriate fix to the detected problem. The fix may be the automatic downloading of a patch or program, or may comprise notifying the Remote Management server 200 of the condition. In addition, based on the information detected by usage collector 120, the management application 140 may cause other management tools to be downloaded to assist in effectively managing the access point.

Referring still to the exemplary embodiment of FIG. 1, the Remote Management server 200 includes a remote monitor 250 and a database 225. The remote monitor 250 communicates with the local monitor 170 the access point 100, using a standard protocol such as HTTP or HTTPS. The remote monitor 250 determines what the state of each access point is by polling each of the local monitors 170 for summary information. In the event that the remote monitor 250 desires further information, it may query the local monitor 170 to request other information.

The remote monitor 250 assists the local monitor 170 and its associated applications in locating and downloading the appropriate programs to resolve issues encountered at the access point, or to facilitate and enhance the services offered to guests. For example, the remote monitor 250 makes available various diagnostic and management programs based on the metalanguage associated with certain programs stored in database 225. The metalanguage includes information identifying the applicable use for a program. Thus, for example, program AX may have a meta-tag of WiFi bandwidth, to indicate that program AX may be useful in diagnosing bandwidth problems between an access point and a Guest Computer communicating via wireless transmissions. The Remote Monitor 250 selects programs to download from the database 225 based on particular conditions or patterns of usage encountered at access points, and the metalanguage identifier for the stored programs.

The database 225 may be a conventional type database, or may comprise an object-oriented database. The database includes a library of programs that may be indexed by meta-tags. The database also includes tables that identify the types of problems that may be or which have been encountered by access points, and the recommended action to take. The database also stores usage information obtained locally from various access points. The database also may include management and data mining software, and may include artificial intelligence software to assist in detecting patterns and making predictions at both the local level and at the system level.

As an example, software capable of detecting fraud analysis may reside in the database 225. If the diagnostic application running locally on an access point identifies certain patterns that might indicate a fraudulent activity, the remote monitor 250 may cause a service pack to be downloaded to prevent the fraudulent activity and cut off the offending Guest. Thus, the Remote Management server 200 may assist in detecting certain patterns or undesirable activities, and provide software to minimize the risk to the local access point, or take corrective action as warranted. In addition, the Remote Management server 200 may provide a message locally to a host to apprise the host of certain malfunctions or improper activity.

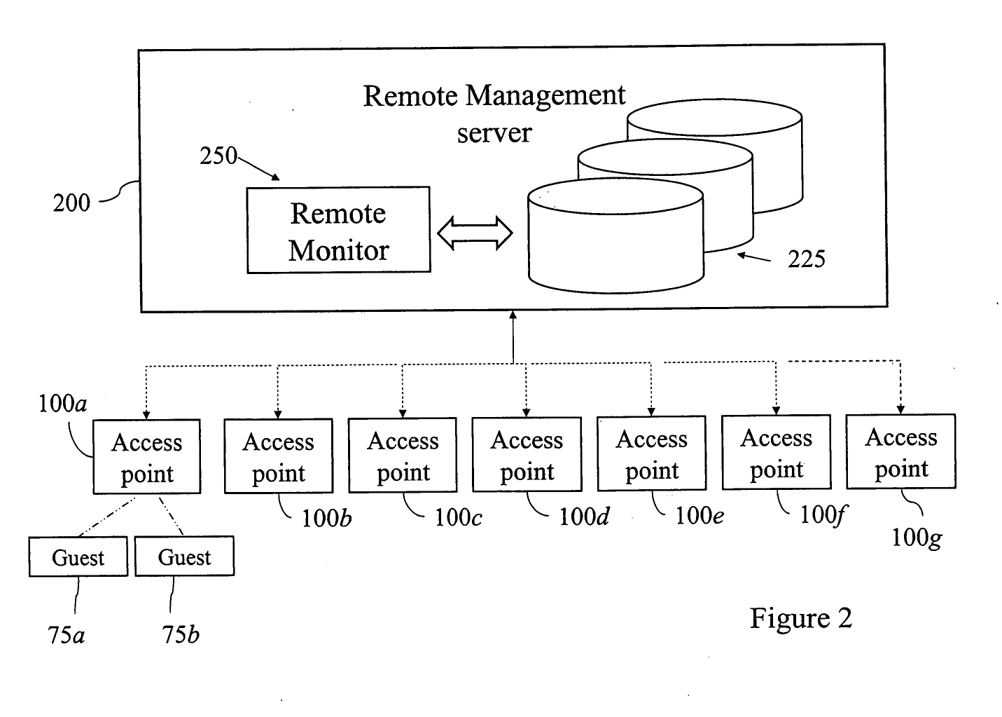

Referring now to FIG. 2, the Remote Management server 200 may be used to remotely manage a plurality of access points 100a-100g via the Internet. Each of the access points may operate as an on-ramp for multiple guests. As shown in FIG. 2, two such guests 75a-75b are shown for purposes of illustration, with the understanding that many more guests may be supported at each access point.

The Remote Management server 200 may include a relatively large database 225 to store usage data from the many access points. The Remote server 200 also may include neural network or other artificial intelligence software capable of performing very sophisticated software analysis of usage patterns. Local monitors in the access points coordinate the collection and filtering of usage patterns at each access point, and then transmit those usage patterns (or a subset of those usage patterns) to the remote monitor 250 for further analysis by the remote server 200. This analysis may result in the detection of patterns, or may result in predictions regarding future usage by one or more guests. Based on the detection of these patterns, or the predictions made by the remote server 200, software may then be downloaded to enhance the operation of an access point. By loading and executing the artificial intelligence software at a remote site, the access points may obtain the benefits of very sophisticated software, without the system requirements or expense that would be incurred if that software was purchased and run locally.

In the event that a Remote Management server is used to configure and maintain a plurality of access points, various levels of management service may be available to the owner of each access point. For example, the Remote Management server may provide a basic management service, a predictive content service suing artificial intelligence resident on the remote server, or full management services with live back-up support.

The above discussion is meant to be illustrative of the principles and various embodiments of the present invention. Numerous variations and modifications will become apparent to those skilled in the art once the above disclosure is fully appreciated. For example, although the above description of the access point focuses on the ability to provide Internet access to Guests, it should be understood that this concept is meant to extend to future iterations of the Internet. As one skilled in the art will appreciate, the provision of such services can be readily implemented in the systems described above. It is intended that the following claims be interpreted to embrace all such variations and modifications.

1. An access point, comprising:
a web server interface that couples one or more guests to the Internet;
a usage collector application that monitors usage of all of said guests;
web cache software that caches web pages that may be of interest to one or more guests in a local memory of the access point.

2. The access point of claim 1, wherein the web cache software predicts web pages that may be of interest to a guest based on that guest's usage pattern, and caches those pages in local memory.

3. The access point of claim 2, wherein the web cache software initiates a signal to the guest indicating that the cached pages are available for viewing.

4. The access point of claim 1, wherein an web cache software caches web pages that have been accessed by multiple guests.

5. The access point of claim 1, wherein each of said guests includes an identification mechanism which is used by said usage collector to compile usage information specific to each guest.

6. The access point of claim 5, further comprising a local monitor that collects usage information from the usage collector application and provides further analysis of the usage information.

7. The access point of claim 6, wherein the local monitor couples to a remote monitor to provide the further analysis of the usage information to the remote monitor.

8. The access point of claim 7, further comprising a diagnostic application that launches when the usage collector detects an abnormality.

9. The access point of claim 8, further comprising a management application that configures the local monitor to provide summary information to the remote monitor.

10. The access point of claim 8 further comprising a management application that requests programs from the remote monitor based on the result of diagnostic application.

11. The access point of claim 10, wherein the web cache application, diagnostic application, and management application may be dynamically modified based on guest usage.

12. A method of providing guests with Internet service, comprising:
detecting a request for Internet access from a guest;
monitoring usage patterns of the guest; and
predicting information that may be of interest for the guest based on the guest's usage patterns; and
locally caching the information that may be of interest to the guest, prior to the time that the guest requests the information.

13. The method of claim 12, further comprising transmitting information relating to the guest's usage patterns to a remote server, and analyzing the guest's usage patterns at the remote server using artificial intelligence software, and correlating the guest's usage patterns with previously detected usage patterns to predict future usage patterns of the guest.

14. The method of claim 12, further comprising informing the guest of the locally cached information.

15. The method of claim 12, wherein the act of predicting includes considering usage patterns of other guests.

16. The method of claim 12, wherein multiple guests may request and receive Internet service at substantially the same time.

17. A system for remotely managing a plurality of Internet access points, comprising:
a plurality of access points that provide Internet access for one or more guests, each of said access points including a web server interface and a usage collector application, with the usage collector application detecting information relating to guest usage;
a remote management server that couples to said plurality of access points via the Internet, said remote server including a remote monitor and a database;
wherein the information relating to guest usage may be transferred from the plurality of access points to the remote management server, and the remote management server analyzes the guest usage using software stored in said database to detect usage patterns, and the remote monitor downloads information to one or more access points to enhance the operation of the access point based on the detected usage pattern.

18. The system of claim 17, wherein the usage collector application also detects information relating to system usage, and said information relating to system usage also is transferred to the remote management server for analysis.

19. The system of claim 17, wherein at least one of the access points is a wireless access point that couples to the one or more guests via a wireless transmission medium.

20. The system of claim 17, wherein the software stored in the database and used to detect usage patterns comprises artificial intelligence software.

21. The system of claim 20, wherein the artificial intelligence software predicts web pages that may be of interest to guests based on usage patterns, and the access points include a web cache application for locally caching web pages predicted to be of interest to guests.

22. The system of claim 20, wherein the artificial intelligence software detects improper activity based on usage patterns, and provides instructions to an access point to take corrective action to minimize the effect of the improper activity.

23. The system of claim 17, wherein the access points include a diagnostic application that analyzes the access points to detect possible errors.

24. The system of claim 23, wherein the diagnostic software may signal the remote monitor to download a program to an access point to assist in resolving a detected error condition.

25. An Internet on-ramp that permits multiple guests to obtain Internet access, comprising:
means for interfacing said access point with the multiple guests;
means for coupling the access point to the Internet;
means for monitoring requests made by a guest to collect information on a guest's usage;
means for selecting content that may be of interest to the guest based on the guest's usage; and
means for locally storing content that may be of interest to the user.

26. The on-ramp of claim 25, wherein the means for monitoring requests also monitors operational parameters related to said on-ramp.

27. The on-ramp of claim 25, further comprising means for diagnosing malfunctions of said on-ramp.

28. The on-ramp of claim 26, further comprising means for managing said on-ramp.

29. The on-ramp of claim 28, wherein the selecting means, diagnosing means, and managing means may be dynamically modified based on the guest's usage detected by said monitoring means.
